(19) United States
(12) Patent Application Publication
(10) Pub. No.: US 2004/0047428 A1
(43) Pub. Date: Mar. 11, 2004

(54) Transmitter for outputting differential signals of different voltage levels

(76) Inventors: Kuei-Chun Teng, Hsin-Chu Hsien (TW); Shin-Lin Wang, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,972

(22) Filed: Sep. 5, 2002

(51) Int. Cl. H04L 27/04

(52) U.S. Cl. 375/295

(57) ABSTRACT

A differential signal transmitter including a driver circuit that generates a differential signal in response to data input. The amplitude of the voltage swings in the differential circuit is controlled by an electrical bias. Two data inputs, one being the original Data and the other being Data bar, are connected to the transistors and cause the required current swings. The transmitter further includes a control circuit with an input for a single-bit control line for adjusting the bias to produce different swing amplitudes according to a control indicator inputted from the control line. The control circuit inputs one or more current sources and outputs the sum of one or more of the current sources according to the control indicator and the outputted current is used as the electrical bias.

### BACKGROUND OF INVENTION

1. Field of the Invention

The present invention relates to a transmitter for differential signaling. More specifically, a transmitter for differential signaling outputting selectable low-voltage currents is disclosed.

2. Description of the Prior Art

Swing differential signaling is a low-voltage technology used in data transmission systems. The use of low-voltage differential signaling for data transmission has grown rapidly due to the low power dissipation, high signal-to-noise ratio, low EMI emission, and high transmission speed characteristics inherent in such a system. Today”s differential signaling systems usually have a swing, or peak-to-peak amplitude of 600 mv or less, depending on the particular derivation in use.

Please refer to FIG. 1 that is a simple circuit diagram of a prior art differential signaling transmitter 10. Transmitter 10 comprises a bias 12 regulating two electrical sources 14, 16, a ground 32, two transistors 24, 26, two inverted transistors 20, 22, and a resistor 18 (R2). Transmitter 10 also comprises two inputs, a first input for data and a second input for inverted data (data bar).

The bias 12 controls the inputted current of the current source 14 to fall within a specified range. When the inputted data is high (thus data bar is low) transistors 24 and 22 are turned on allowing current to flow from the current source 14 through transistor 22 to a node B. From the Node B, the current VoutP flows to the resistor 18. From the resistor 18, the current VoutN flows to a node A and through the transistor 24 and the current source 16 to the ground 32. When the inputted data is low (thus data bar is high) transistors 20 and 26 are turned on allowing current to flow from the current source 14 through transistor 20 to the node A. From the node A, the current VoutN flows to the resistor 18 (R2). From the resistor 18, the current VoutP flows to the ground 32 via the node B, the transistor 26, and the current source 16. The outputted voltage when data is high is equal to VoutP VoutN which equals I*R2 and corresponds to a “1” in the differential signal. The outputted voltage when data is low is equal to VoutP VoutN which equals −I*R2 and corresponds to a “0” in the differential signal.

Currently there are at least three major types of swing differential signaling systems commonly used. First, is a Low Voltage Differential Signaling (LVDS) system with current swings in the 247 mv 454 mv range. A swing of 350 mv would be considered typical for LVDS. Next is a Mini-LVDS system with current swings in the 300 mv 600 mv range, typically about 450 mv. Thirdly, a Reduced Swing Differential Signaling (RSDS™) system generally supports a current swing of 200 mv but includes a current swing range of 100 mv 400 mv.

The benefits provided by a low-voltage differential signaling transmitter 10 can be offset when different applications within the same system require different swing voltage levels. The choice of which kind of differential signaling transmitter 10 to use is related to numerous design considerations including bandwidth required, length of the connection, driver transition time, and signal quality, all of which are application specific and often incompatible with each other. In such a scenario, system designers or administrators are faced with a choice of decreased efficiency or the cost and complications additional transmitters 10 for each voltage range needed.

### SUMMARY OF INVENTION

It is therefore a primary objective of the claimed invention to provide a differential signal transmitter that can be efficiently used with a plurality of differential signal applications each requiring a different swing voltage range, reducing costs and increasing functional efficiency.

Briefly summarized, the claimed invention discloses a differential signal transmitter including a driver circuit that generates a differential signal in response to data input. The amplitude of the voltage swings in the differential signal is controlled by an electrical bias to the driver circuit. Two data inputs, one being the original data and the other being data bar, are connected to the transistors and cause the required current swings.

The claimed invention further includes a control circuit with an input for a single-bit control line for adjusting the bias to produce different swing amplitudes according to a control indicator inputted from the control lines. The control circuit inputs one or more current sources and outputs the sum of one or more of the current sources according to the control indicator and the outputted current is used as the electrical bias for the driver circuit. For example, if the control indicator is set high, the control circuit outputs a current level that is used as a bias to produce a differential signal with a first predefined voltage amplitude. If the control indicator is set low, the control circuit outputs a second current level that is used as a bias to produce a differential signal with a second predefined voltage amplitude.

Another example of the claimed invention works similarly to the above example except that the control circuit receives a plurality of control bits via one or more control lines and adjusts the bias to produce a plurality of differential swing current amplitudes according to the control indicators received by the control circuit.

It is an advantage of the claimed invention that a single differential signal transmitter can be adjusted to produce a plurality of differential swing current amplitudes according to the control indicators received by the control circuit, eliminating a need for separate transmitters for each different kind of differential signal required in different applications. The claimed invention thereby reduces costs and increases functional efficiency.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a simple circuit diagram of a differential signal transmitter according to the prior art.

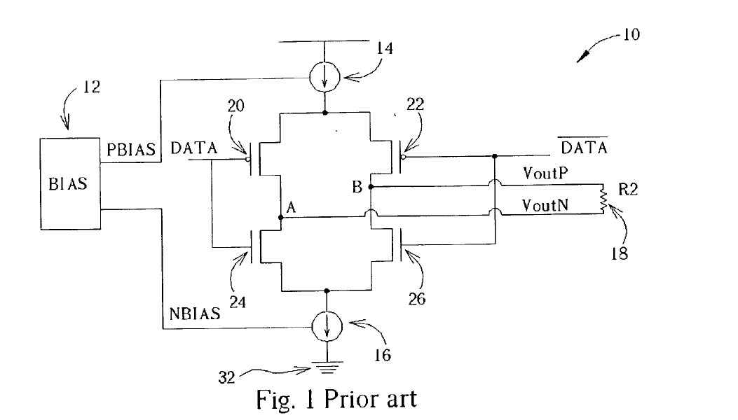

FIG. 2 is a simple circuit diagram of a differential signal transmitter according to the present invention.

FIG. 3 is a simple circuit diagram of a control circuit of the differential signal transmitter of FIG. 2.

### DETAILED DESCRIPTION

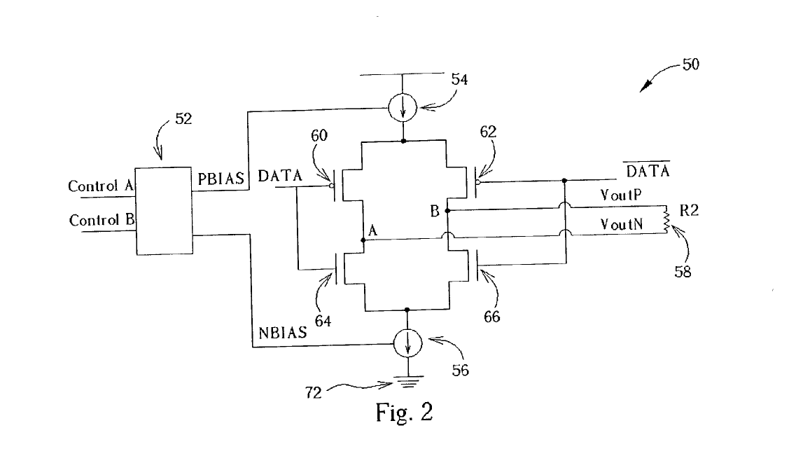

Please refer to FIG. 2 of a differential signal transmitter according to the present invention. The transmitter comprises a control circuit 52 and a driver circuit 50 including two electrical sources 54, 56, a ground 72, two transistors 64, 66, two inverted transistors 60, 62, and a resistor 58(R2). The driver circuit 50 also comprises two inputs, the first input receives data and a second input receives inverted data (data bar). The operation of the basic driver circuit 50 of the present invention is well known in the art and functionally similar to the prior art described above.

The bias supplied by the control circuit 52 controls the inputted current of the current source 54 to fall within a specified range. When the inputted data is set high (thus data bar is set low) transistors 64 and 62 are turned on allowing current to flow from the current source 54 through transistor 22 to a node B. From the Node B, the current VoutP flows to the resistor 58. From the resistor 58, the current VoutN flows to a node A and through the transistor 64 and the current source 56 to the ground 72. When the inputted data is low (thus data bar is high) transistors 60 and 66 are turned on allowing current to flow from the current source 54 through transistor 60 to the node A. From the node A, the current VoutN flows to the resistor 58. From the resistor 58, the current VoutP flows to the ground 72 via the node B, the transistor 66, and the current source 56. The outputted current when data is high is equal to VoutP VoutN which equals I*R2 and corresponds to a “1” in the differential signal. The outputted current when data is low is equal to VoutP VoutN which equals −I*R2 and corresponds to a “0” in the differential signal.

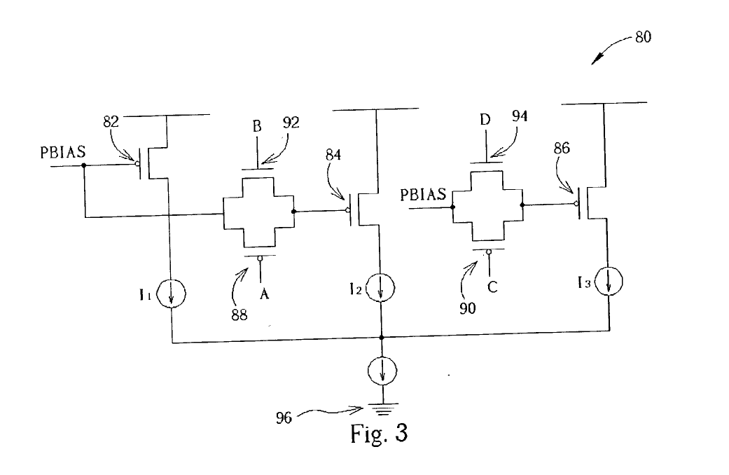

FIG. 3 is a simple circuit diagram of an example control circuit 80 according to the present invention. It is understood that there are numerous ways to implement a control circuit for the present invention and FIG. 3 is merely an illustration of only one possible control circuit. The spirit of the present invention applies to any method of using one or more control indicators to combine one or more current sources and output the combined current to be used as an electrical bias for a differential signal driver.

The control circuit 80 comprises transistors 92, 94, inverted transistors 82, 84, 86, 88, 90, three current sources 11, 12, 13, a ground 96, and an electrical bias PBIAS. In this example, the ground 96 is to be used as a bias for the driver circuit 50. In addition, in this example, the control circuit 80 comprises four inputs A, B, C, D, for receiving control indicators to control the current outputted to the ground 96. It is obvious that a single control indicator can be used to select between to outputted current levels and the present invention is not to be limited by the number of control indicators used. In this example, four control indicators are used for convenience to illustrate a useful application of the present invention.

In operation, the control circuit 80 will function according to the inputted control indicators. In a first example, the control indicators received by the control circuit are as follows: A=0, B=1, C=1, D=0. This scenario turns on transistors 88, 92 while transistors 90, 94 are turned off and results in a total current at the ground 96 equal to I1+I2. In another example, the control indicators received by the control circuit are as follows: A=1, B=0, C=0, D=1. Here, transistors 90, 94 are turned on while transistors 88, 92 are turned off, resulting in a total output current equal to I1+I3. Obviously, other combinations of control indicators result in different resulting output current.

If the current sources I1, I2, I3 are properly chosen, the sum of currents of one or more current sources can be used as a bias to cause the driver circuit 50 to generate a differential signal in a predetermined voltage range. The voltage range generated can be altered merely by changing one or more of the conditional indicators A, B, C, D. For example, the sum of the currents I1 and I2 (as in the first example) can generate a Low Voltage Differential Signaling (LVDS) differential signal with current swings in the 247 mv 454 mv range. A Mini-LVDS differential signal with current swings in the 300 mv 600 mv range can be generated by adjusting the control indicators A, B, C, D appropriately, say to sum currents I1 and I3 (as in the second example). Other combinations of the control indicators A, B, C, D can be used to generate a Reduced TM Swing Differential Signaling (RSDS™) differential signal with a current swing in the range of 100 mv 400 mv.

The present invention has a clear advantage over the prior art by using a control circuit and control indicators to permit a single transmitter to generate different leveled electrical biases for a differential driver circuit. This allows a single transmitter to selectively generate LVDS, Mini-LVDS, and RSDS™ differential signals as well as being able to easily accommodate any future versions of differential signaling.

The present invention offers the benefits of the prior art, that of low power dissipation, high signal-to-noise ratio, low EMI emission, and high transmission speed while eliminating the prior art drawbacks that can result in inefficiency and extra costs when more than one low-voltage differential voltage range is needed. The present invention offers a solution to the compatibility problem.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A differential signal transmitter comprising:
a driver circuit that generates a differential signal in response to inputted data,
a voltage amplitude of the differential signal being controlled by a bias; and
a control circuit comprising a first input for receiving a first control indicator, the control circuit being capable of outputting the bias at different levels according to the first control indicator.

2. The differential signal transmitter of claim 1 wherein the first control indicator is a single bit.

3. The differential signal transmitter of claim 1 wherein the control circuit is capable of outputting the bias at different current levels.

4. The differential signal transmitter of claim 3 wherein when the control circuit outputs the bias at a first current level, the driver circuit generates a Low Voltage Differential Signaling (LVDS) differential signal in response to the inputted data.

5. The differential signal transmitter of claim 3 wherein when the control circuit outputs the first current level as a bias for the driver circuit, the driver circuit generates a Mini-LVDS differential signal in response to inputted data.

6. The differential signal transmitter of claim 3 wherein when the control circuit outputs the first current level as a bias for the driver circuit, the driver circuit generates a Reduced Swing Differential Signaling differential signal in response to inputted data.

7. The differential signal transmitter of claim 1 wherein when the control circuit outputs a predetermined current level as a bias for the driver circuit, the outputted current is a sum of predetermined current sources, the current sources to summed being selected according to the control indicator.

8. The differential signal transmitter of claim 1 wherein the control circuit further comprises a second input for receiving a second control indicator.

9. A method of transmitting a differential signal from a transmitter, the transmitter comprising a driver circuit that generates the differential signal in response to inputted data and a control circuit, an voltage amplitude of the differential signal being controlled by an electrical bias, the method comprising:
receiving a control indicator from a first input of the control circuit;
the control circuit generating the electrical bias at different levels according to the first control indicator; and
generating the differential signal at a voltage amplitude determined by the electrical bias.

10. The method of claim 9 further comprises the driver circuit generating a Low Voltage Differential Signaling (LVDS) differential signal in response to inputted data when the control circuit outputs the electrical bias at a first predetermined level.

11. The method of claim 9 further comprises the driver circuit generating a Mini-LVDS differential signal in response to inputted data when the control circuit outputs the electrical bias at a second predetermined level.

12. The method of claim 9 further comprises the driver circuit generating a Reduced Swing Differential Signaling differential signal in response to inputted data when the control circuit outputs electrical bias at a third predetermined level.
